(19) United States
(12) Patent Application Publication
(10) Pub. No.: US 2011/0107973 A1
(43) Pub. Date: May 12, 2011

(54) Animal Feeder and Method of Use Thereof

(75) Inventor: Bryan Jenkins, Cumming, GA (US)

(73) Assignee: B & R Feeders, LLC

(21) Appl. No.: 12/615,623

(22) Filed: Nov. 10, 2009

(51) Int. Cl. A01K 5/01

(52) U.S. Cl. 119/52.1; 119/52.2

(57) ABSTRACT

An animal feeder formed from assembling a corrugated tube to a base portion. The feeder has an orifice underneath a corrugation of the tube for exit of feed, thereby protecting the feed exit orifice from the effects of inclement weather. The animal feeder may have a weighting material added within the base to provide stability when free standing, or may be secured via straps to a fixed object such as a tree, selectively either at ground level or at an elevated level. The base is secured to the corrugated tube by flexible extensions that have protrusions that engage the inside of one of the ridges of the corrugations of the tube. Securing rings may alternately be utilized.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to apparatuses for providing feed to animals at ground or elevated level, and more particularly to a feeder formed from a flexible corrugated tube that has a covered opening for feed to exit, wherein the opening is covered by a removable cap, and wherein the lower portion of the corrugated tube is removably or permanently secured to a weighted or un-weighted base, and wherein the feeder may be secured to a stationary object.

2. Description of Related Art

Many people desire to feed animals with different reasons for doing so. Some wish merely to provide a food source for animals; others may wish to attract animals to the feed area to facilitate in locating animals for harvesting.

As diverse as the reasons for doing so, there are various approaches to feeding animals. Animals that are small and which cannot climb require feed to be placed proximate a ground area. Taller animals prefer not to have to lower their head (thereby preventing their observing danger approaching) and thus prefer higher sources of food.

Various attempts to solve these difficulties have arisen. One such previous device utilizes a tube suspended from a tree limb or secured to the tree. However, while using a corrugated tube in one embodiment, this device requires an upward facing opening for an animal to insert its snout into in order to obtain feed. This allows exposure to the elements and does not allow feed to exit onto a platform for use by smaller animals. Another device utilizes a base, a tube and a cover, but the tube is of uniform dimension, not corrugated, and thus lacks an overhang to protect the feed from inclement weather.

Another feeding device utilizes a tube with an adjustable, sloping plate to control the amount of feed delivered to a bottom portion. This device is principally for caged animals and has a side opening that still affords little protection from the elements and which is not suitable for field assembly from simple components. Another device feeds from a tubular section into an external bowl and is again more suited for indoor or protected use. Yet another device utilizes a vertical plate to restrict flow from the feed source.

Unfortunately, such prior devices lack any protection for the feed exit opening, and, thus, the feed exit opening is exposed to the elements, which may result in plugging thereof.

Therefore, it is readily apparent that there is a need for an animal feeder that can be assembled in a field environment and that provides a protected feed exit orifice, wherein the animal feeder may selectively be placed at different heights, or alternately, be selectively free standing or secured to a fixed object.

### BRIEF SUMMARY OF THE INVENTION

Briefly described, in a preferred embodiment, the present invention overcomes the above-mentioned disadvantages and meets the recognized need for such a device by providing an animal feeder assembled from a corrugated tube, a cover for the top of the corrugated tube and a base. Feed exits from underneath a corrugation of the tube, thereby protecting the feed exit orifice from the effects of inclement weather. Feed passes over a horizontal baffle within the feeder to prevent packing of the feed against the exit orifice.

The animal feeder may be placed on the ground with a weighting material in the base, or secured via straps to a fixed object such as a tree, either at ground level or at an elevated level as selected by the user of the animal feeder.

The base is secured to the corrugated tube by extensions that have protrusions that engage the inside of one of the ridges of the corrugations of the tube. Securing rings may alternately be utilized to either fixedly secure or removably secure the base to the corrugated tube.

According to its major aspects and broadly stated, the present invention in its preferred form is an animal feeder.

An animal feeder comprising a corrugated tube having a top end, a bottom end in communication with a base, and corrugations that have an underneath portion, ridges and valleys. The base comprises a fastener for securing the corrugated tube to the base. There is an outlet orifice disposed on the underneath portion of a lower corrugation of the corrugated tube. The base has a containment portion to hold a weighting material, including sand, gravel, dirt, water, which may be field-installed. The animal feeder may alternatively comprise the outlet orifice being disposed on the base, such that the outlet orifice remains underneath a portion of a corrugation of the corrugated tube.

The fastener comprises a plurality of flexible extensions that each has a protrusion extending outwardly therefrom. The protrusion cooperatively engages an inside portion of one of the ridges, thereby securing the corrugated tube to the base. Alternately, the fastener may comprise a threaded securing ring and the flexible extensions may comprise inner threads, wherein the threaded securing ring engages the inner threads, urging the outwardly-disposed protrusions into the inside portion of the ridge as the threaded securing ring is tightened. In a further alternative, the flexible extensions could comprise an inside with a relieved, or grooved, area, and the fastener could comprise a securing ring with an outer edge that engages the relieved area, thereby urging the protrusions into the inside of the ridged area and locking the corrugated tube to the base. A screen may be disposed proximate the flexible extensions, on the inside or the outside thereof, to prevent feed from passing through gaps between the flexible extensions.

The animal feeder further comprises a strap for securing to an object, such as a tree. The strap engages at least one of the valleys of the corrugated tube. The animal feeder also has a cover with a perimeter, and the cover comprises a cap and an elastic retainer. The cover comprises a plurality of slots disposed circumferentially in its perimeter, and the elastic retainer engages the slots passing through same to engage at least one of the valleys, thereby securing the cover to the top end of the corrugated tube.

The animal feeder further comprises a horizontally-disposed baffle plate therewithin that causes feed to first flow directionally away from the outlet orifice prior to flowing back toward the outlet orifice to exit the animal feeder by the outlet orifice.

The animal feeder is utilized by obtaining components as described hereinabove and assembling same together, thereby urging the protuberances into the inside of the ridge by installation of a securing ring, filling the animal feeder with feed, installing the cover cap on the animal feeder, and placing the animal feeder at a selected location. The securing ring may alternatively have an external edge that engages a relieved area on an inside portion of the flexible extensions, or may be threaded with external threads thereon that engage internal threads on the flexible extensions.

More specifically, the present invention is an animal feeder having a corrugated tube connected to a base, with a cap secured to the corrugated tube by an elastic band. The corrugated tube has an interior, a top, a bottom, an overhang and an orifice for exit of feed. The cap has a relieved section to receive the elastic band and the base has flexible extensions with locking teeth thereon. The orifice is disposed on and under an overhang from a ridge of the corrugated tube, placing the orifice under the ridge and protecting the orifice from rain or similar inclement weather. The corrugations of the corrugated tube comprise the aforementioned ridges and corresponding valleys, wherein the ridges have an interior side. The base further comprises a platform, a ridged floor, a horizontal baffle, a containment area for a weighting material such as sand or water, a lid and a filling aperture for the containment area. The base and the corrugated tube may have braces formed into a generally V-shaped opening that facilitates securing the animal feeder to a tree or similar circular-surfaced object.

In use, the corrugated tube is assembled to the base by pressing the flexible extensions toward each other and inserting the flexible extensions into the interior of the corrugated tube through its bottom. Once the flexible extensions are fully inserted, the locking teeth thereon engage the ridge interiors of the corrugated tube, thereby locking the base to the corrugated tube.

The animal feeder is subsequently placed in a selected location and filled with feed, or it may be filled with feed first and then secured in its desired location. The latter would typically be selected when it is desired to place the animal feeder in a raised location, such as by securing the animal feeder to a tree.

Once the animal feeder is filled with feed, the cap is secured over the top of the corrugated tube, wherein the elastic band engages the relieved sections of the cap, passing therein and further engaging a valley of the corrugated tube, thereby retaining the cap securely on the corrugated tube.

The animal feeder may selectively be disposed on a ground surface in a free standing mode or alternatively may be secured to an object. When securing the animal feeder to a tree or similar circular-surfaced object, the animal feeder is secured by straps, wherein the straps pass around the tree and engage valleys of corrugated tube, and the straps are retained and tightened by buckles.

Flow of feed to the orifice is impeded by the horizontal baffle, wherein the horizontal baffle has a proximal portion closer to the orifice and a distal portion farther from the orifice. Feed is impeded by the proximal portion from a direct path to the orifice, thereby flowing around the distal portion onto the ridged floor. As animals take feed from the orifice, the feed flows across the ridged floor from below the distal portion to the orifice, thereby preventing plugging of the orifice from too large a pressure from the column of feed within the corrugated tube. Some feed will exit from the orifice and land on the platform portion of the base, thereby exposing a small portion of feed that serves to attract game, while the bulk of feed will remain in the corrugated tube until the animal licks or nibbles at the orifice, thereby causing some feed to fall there from.

In an alternate embodiment, the animal feeder has a base and a locking ring that has a peripheral lip that engages a groove on the interior of the flexible extension of the base. Once the corrugated tube is installed over the flexible extensions, the locking ring is pressed into the flexible extensions forcing them apart so that the peripheral lip engages the groove and drives the locking teeth on the flexible extensions into the interior of a ridge, thereby fixedly securing the corrugated tube to base. In this embodiment, the locking ring is pressed from the interior of the corrugated tube by hand or other extended object that can reach into the interior of the corrugated tube to press on the locking ring. Subsequently, the animal feeder is filled with feed, the cap is installed and the animal feeder is placed in a selected location as described previously.

A screen may alternately be disposed under or over the flexible extensions on the inside or outside thereof. The screen prevents feed from flowing through the gap formed between the flexible extensions and incorrectly exiting the animal feeder from the flexible extensions if the bottom of the corrugated tube does not fully cover the flexible extensions.

In another alternate embodiment, the animal feeder has a threaded securing ring having a threaded portion on the outside thereof, a periphery and handle. In this embodiment, the base has a cooperative inside thread on the interior of the flexible extensions that is engaged by the outside thread of the securing ring.

To assemble corrugated tube of this embodiment to its base, the flexible extensions are pressed together as before and inserted through the bottom of the corrugated tube. The threaded securing ring is then installed by reaching into the interior of the corrugated tube from the top and grasping the handle and rotating the threaded securing ring. The outside thread on the securing ring engages the inside thread on the flexible extensions and the threaded securing ring presses into the flexible extensions forcing them apart, driving the locking teeth into the interior of a ridge, thereby removably securing the corrugated tube to its base. Subsequently, the animal feeder is filled with feed, the cap is installed and the animal feeder is disposed in a selected location as described hereinabove.

In another alternate embodiment, the animal feeder has a base with an extended portion that has the orifice therein, such that the orifice is disposed below and under a ridge of the corrugated tube.

Accordingly, a feature and advantage of the present invention is its ability to feed animals of different heights.

Another feature and advantage of the present invention is its ability to provide feed on ground level and at elevated levels.

Still another feature and advantage of the present invention is its ability to be quickly assembled in the field.

Yet another feature and advantage of the present invention is its ability to protect its feed exit orifice from inclement weather.

Yet still another feature and advantage of the present invention is that it may be selectively self-standing or secured to a fixed object.

A further feature and advantage of the present invention is it can be disassembled when so desired.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a perspective view of an animal feeder according to a preferred embodiment, shown disposed on a ground surface, secured to a tree;

FIG. 1B is a perspective view of an animal feeder according to a preferred embodiment, shown disposed at an elevated level, secured to a tree;

FIG. 2 is a perspective view of a bottom portion of an animal feeder according to a preferred embodiment;

FIG. 3 is a perspective view of a bottom portion of an animal feeder according to a first alternate embodiment;

FIG. 4 is a perspective view of a bottom portion of an animal feeder according to a second alternate embodiment;

FIG. 5A is a bottom perspective view of a cap for an animal feeder according to a preferred embodiment;

FIG. 5B is a bottom view of a cap for an animal feeder according to a preferred embodiment;

FIG. 6A is a perspective view of a lower portion of an animal feeder according to a preferred embodiment, showing animal feed therewithin; and

FIG. 6B is a perspective view of a base portion of an animal feeder according to an alternate embodiment.

### DETAILED DESCRIPTION OF THE PREFERRED AND SELECTED ALTERNATE EMBODIMENTS OF THE INVENTION

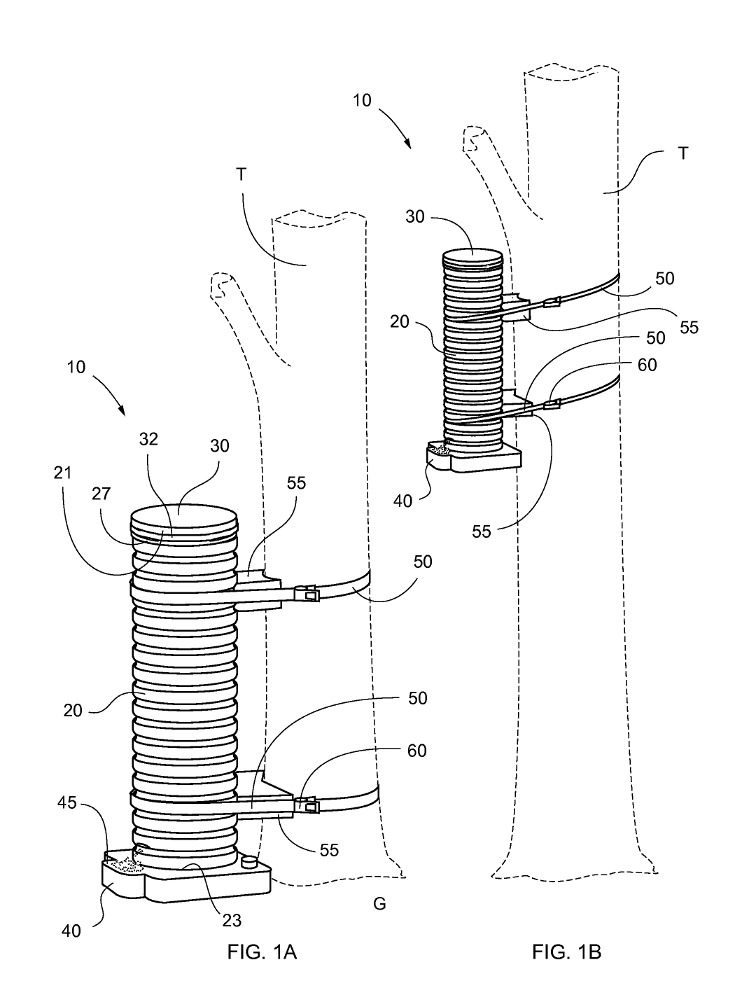

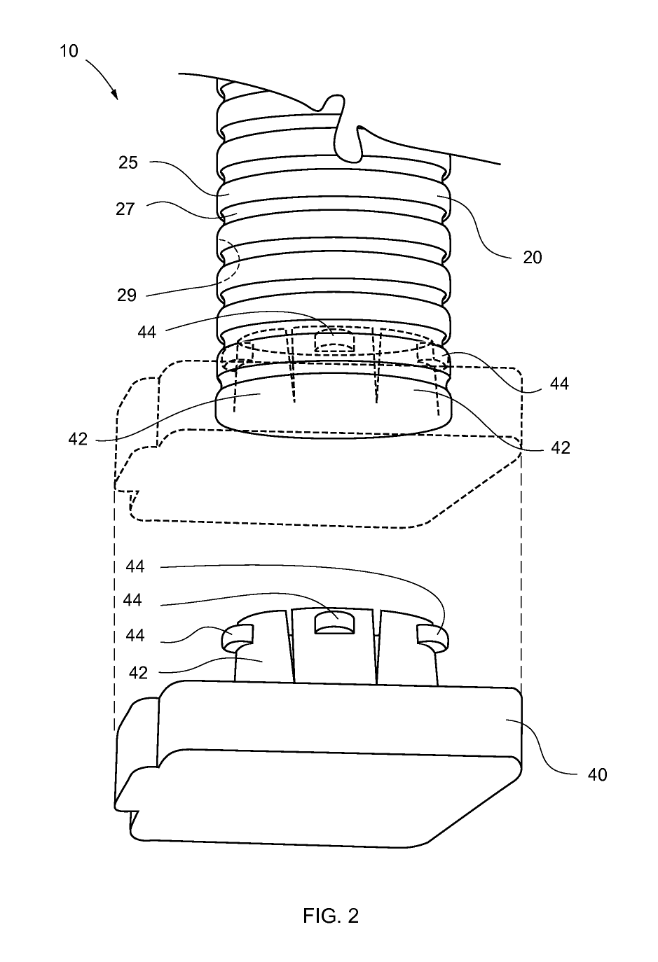

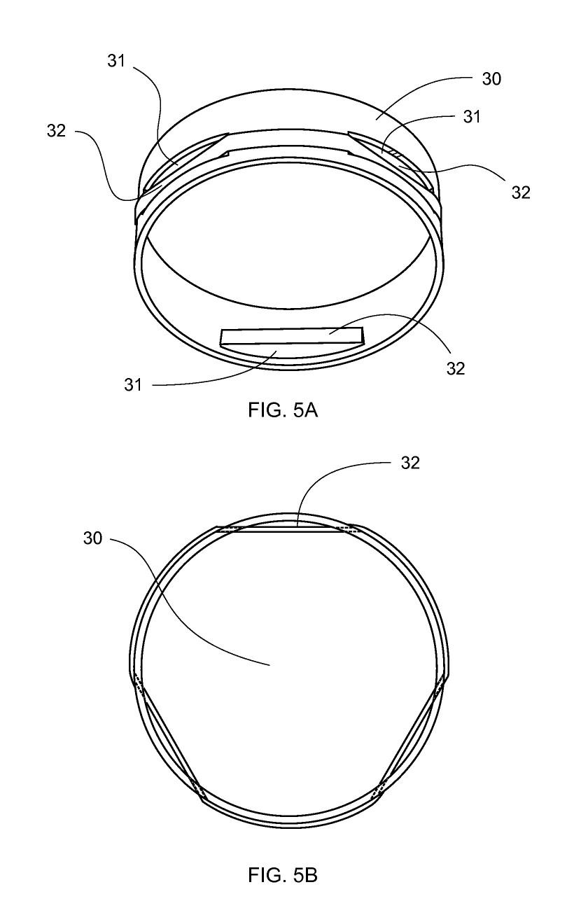

In describing the preferred and selected alternate embodiments of the present invention, as illustrated in FIGS. 1-6B, specific terminology is employed for the sake of clarity. The invention, however, is not intended to be limited to the specific terminology so selected, and it is to be understood that each specific element includes all technical equivalents that operate in a similar manner to accomplish similar functions.

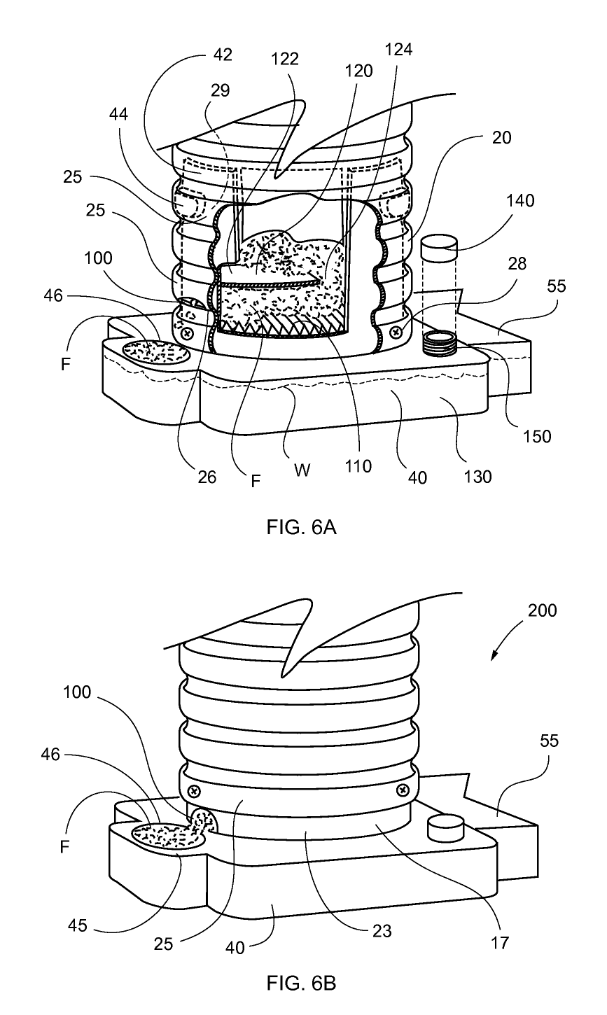

Referring now to FIGS. 1A, 1B, 2, 5A, 5B and 6A, the present invention in a preferred embodiment is animal feeder 10, wherein animal feeder 10 preferably comprises corrugated tube 20, cap 30, elastic band 32 and base 40, wherein corrugated tube 20 preferably comprises, interior 19, top 21, bottom 23, overhang 26 and orifice 100, and wherein cap 30 preferably comprises relieved section 31, and wherein base preferably comprises flexible extensions preferably having locking teeth 44 disposed thereon. Orifice 100 is preferably disposed under and on overhang 26, thereby preferably placing orifice 100 under ridge 25, wherein orifice 100 is protected from rain, or other inclement weather. The corrugations of corrugated tube 20 preferably comprise ridges 25 and valleys 27, wherein ridges 25 preferably comprise ridge interiors 29. Base 40 further preferably comprises platform 45, ridged floor 110, horizontal baffle 120, containment area 130, lid 140 and filling aperture 150 (all best shown in FIG. 6A) for containment area 130, wherein containment area 130 may selectively be filled with a weighting agent, such as, for exemplary purposes only, water W, sand or the like. Platform 45 comprises dished indentation 46, wherein dished indentation 46 facilitates retention of feed F on platform 45. Base 40 and corrugated tube 20 may selectively have braces 55 disposed thereon (best shown in FIGS. 1A, 1B and 6A), wherein braces 55 preferably comprise a generally V-shaped opening 56 that facilitates securing animal feeder 10 to a fixed object having a generally circular surface, such as, for exemplary purposes only, tree T.

In use, corrugated tube 20 is preferably assembled to base 40, wherein flexible extensions 42 are preferably pressed toward each other and are preferably inserted into interior 19 through bottom 23 of corrugated tube 20. Once flexible extensions 42 are fully inserted, locking teeth 44 preferably engage ridge interiors 29, thereby locking base 40 to corrugated tube 20. It will be recognized by those skilled in the art that other means of fastening corrugated tube 20 to base 40 could be utilized, such as, for exemplary purposes only, fasteners 28.

Animal feeder 10 is preferably subsequently disposed in a selected location and filled with feed F. Alternatively, animal feeder 10 may be filled with feed F and then secured in its desired location, particularly when it is desired to place animal feeder 10 in a raised location by securing animal feeder 10 to an object, such as, for exemplary purposes only, tree T.

Once animal feeder is filled with feed F, cap 30 is preferably secured over top 21 of corrugated tube 20, wherein elastic band 32 preferably engages relieved sections of cap 30, passing therein and further engaging valley 27 of corrugated tube 20, thereby preferably retaining cap 20 securely on corrugated tube 20.

Animal feeder 10 may selectively be disposed on ground G, wherein animal feeder 10 may be free standing or alternatively may be secured to tree T. When securing animal feeder 10 to tree T or similar circular-surfaced object, animal feeder 10 is preferably secured by straps 50, wherein straps 50 preferably pass around tree T and are preferably retained and tightened by buckles 60, and wherein straps 50 preferably engage valleys 27 of corrugated tube 20.

Flow of feed F to orifice 100 is preferably impeded by horizontal baffle 120, wherein horizontal baffle 120 preferably comprises proximal portion 122 closer to orifice 100 and distal portion 124 farther from orifice 100. Feed F is preferably impeded by proximal portion from a direct path to orifice 100, thereby preferably flowing around distal portion 124 onto ridged floor 110. As animals take feed from orifice 100, feed F preferably flows across ridged floor 110 from distal portion 124 to orifice 100, thereby preferably preventing plugging of orifice 100 from too great a pressure from feed F. Some feed will exit from orifice and land on platform 45, thereby preferably exposing a small portion of feed F that serves to attract game, while the bulk of feed F will preferably remain in corrugated tube 20 until the animal licks or nibbles at orifice 100 causing feed F to fall there from.

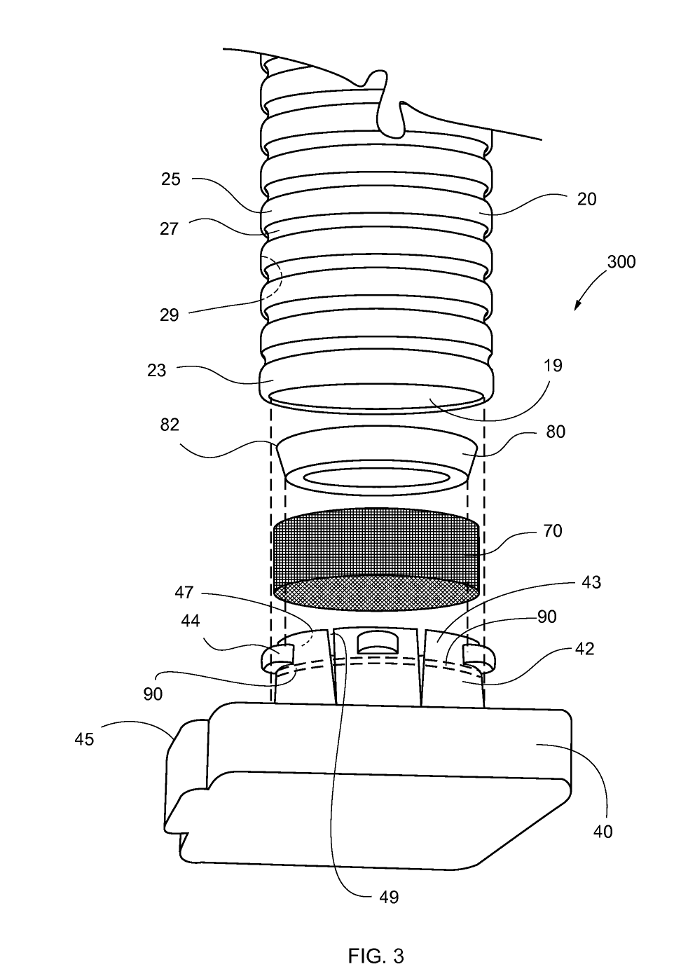

Referring now more specifically to FIG. 3, illustrated therein is an alternate embodiment of animal feeder 10, wherein the alternate embodiment of FIG. 3 is substantially equivalent in form and function to that of the preferred embodiment detailed and illustrated in FIGS. 1A, 1B, 2, 5A, 5B and 6A except as hereinafter specifically referenced. Specifically, the embodiment of FIG. 3 comprises animal feeder 300 having base 40 and locking ring 80, wherein locking ring 80 comprises peripheral lip 82, and wherein base 40 comprises flexible extensions 42 having teeth 44 thereon, and wherein flexible extensions 42 further comprise groove 90.

Once corrugated tube 20 is disposed over flexible extensions 42 as described hereinbefore, locking ring 80 is pressed into flexible extensions 42 forcing same apart, wherein peripheral lip 82 engages groove 90 and driving locking teeth 44 into ridge interior 29, thereby fixedly securing corrugated tube 20 to base 40. In this embodiment, locking ring 80 is pressed from interior 19 of corrugated tube 20 by hand or other extended object that can reach into interior 19 of corrugated tube 20 to locking ring 80.

Subsequently, animal feeder 10 is filled with feed F, cap 30 is installed and animal feeder 10 is disposed in a selected location as described hereinabove.

Screen 70 may alternately be disposed within flexible extensions 42 proximate inside 47 or without flexible extensions 42 proximate outside 43, wherein screen 70 prevents feed F from flowing via gap 49 between flexible extensions 42 and un-scheduledly exiting animal feeder 300 in the event that bottom 23 of corrugated tube 20 does not fully cover flexible extensions 42.

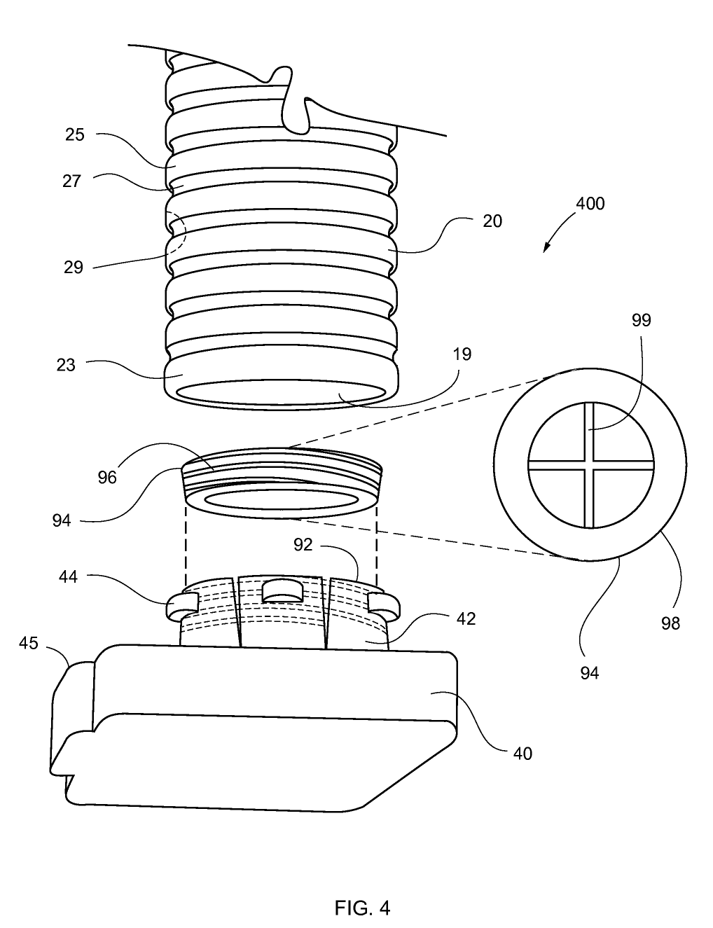

Referring now more specifically to FIG. 4, illustrated therein is an alternate embodiment of animal feeder 10, wherein the alternate embodiment of FIG. 4 is substantially equivalent in form and function to that of the preferred embodiment detailed and illustrated in FIGS. 1A, 1B, 2, 5A, 5B and 6A except as hereinafter specifically referenced. Specifically, the embodiment of FIG. 4 comprises animal feeder 400, wherein animal feeder 400 comprises base 40 and threaded securing ring 94, wherein threaded securing ring 94 comprises outside thread 96, periphery 98 and handle 99, and wherein base 40 comprises flexible extensions 42 having inside thread 92 and teeth 44 thereon.

To assemble corrugated tube 20 to base 40, flexible extensions 42 are pressed together and inserted through bottom 23 of corrugated tube 20. Threaded securing ring 94 is then installed by reaching into interior 19 of corrugated tube 20 from top 21 thereof, grasping handle 99 and rotating threaded securing ring 94. Outside thread 96 engages inside thread 92 and, similarly to the embodiment of FIG. 3 described hereinabove, threaded securing ring 94 presses into flexible extensions 42 forcing same apart, driving locking teeth 44 into ridge interior 29, thereby removably securing corrugated tube 20 to base 40.

Subsequently, animal feeder 10 is filled with feed F, cap 30 is installed and animal feeder 10 is disposed in a selected location as described hereinabove.

Referring now more specifically to FIG. 6B, illustrated therein is an alternate embodiment of animal feeder 10, wherein the alternate embodiment of FIG. 6B is substantially equivalent in form and function to that of the preferred embodiment detailed and illustrated in FIGS. 1A, 1B, 2, 5A, 5B and 6A except as hereinafter specifically referenced. Specifically, the embodiment of FIG. 6B comprises animal feeder 200, wherein animal feeder 200 comprises base 40 having extended portion 17, wherein extended portion 17 comprises orifice 100 therein, and wherein orifice 100 is disposed below and under ridge 25 of corrugated tube 20.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An animal feeder comprising:
a corrugated tube having a top end, a bottom end and corrugations, wherein said corrugations have an underneath portion;
a base, wherein said bottom end is in communication with said base, and wherein said base comprises a fastener for securing said corrugated tube to said base; and
an outlet orifice disposed on said underneath portion of a lower corrugation of at least one of said corrugations.

2. The animal feeder of claim 1, wherein said corrugated tube comprises ridges and valleys.

3. The animal feeder of claim 1, wherein said base comprises an enclosed volume for containing a weight.

4. The animal feeder of claim 3, wherein said weight is selected from the group consisting of sand, gravel, dirt, water and combinations thereof.

5. The animal feeder of claim 2, wherein said fastener comprises a plurality of flexible extensions each having an outwardly-disposed protrusion thereon.

6. The animal feeder of claim 5, wherein each of said outwardly-disposed protrusions cooperatively engages an inside portion of at least one of said ridges, thereby securing said corrugated tube to said base.

7. The animal feeder of claim 6, wherein said fastener further comprises a threaded securing ring and wherein said flexible extensions comprise inner threads, and wherein said threaded securing ring engages said inner threads, and wherein said outwardly-disposed protrusions are urged into said inside portion when said threaded securing ring is tightened.

8. The animal feeder of claim 5, wherein said flexible extensions comprise an outside and an inside, and wherein said inside comprises a relieved area, and wherein said fastener comprises a securing ring adapted to engage said relieved area.

9. The animal feeder of claim 8, further comprising a screen, wherein said screen is disposed proximate said flexible extensions, and wherein said screen prevents feed from passing through gaps between said flexible extensions.

10. The animal feeder of claim 2, further comprising a strap for securing said animal feeder to an object, wherein said strap engages at least one of said valleys.

11. The animal feeder of claim 2, further comprising a cover having a perimeter, wherein said cover comprises a cap and an elastic retainer, and wherein said cover comprises a plurality of slots disposed circumferentially in said perimeter, and wherein engagement of said elastic retainer with said slots permits engagement of said elastic retainer with at least one of said valleys, and wherein said engagement of said elastic retainer with said at least one valley secures said cover to said top end.

12. The animal feeder of claim 1, further comprising a horizontally-disposed baffle plate within said animal feeder, and wherein said horizontally-disposed baffle plate causes feed to first flow directionally away from said outlet orifice prior to flowing toward said outlet orifice and exiting said outlet orifice.

13. The animal feeder of claim 1, wherein said fastener comprises a plurality of flexible extensions each having an outwardly-disposed protrusion thereon, and wherein said outwardly-disposed protrusions cooperatively engage an inside of a ridged portion of said corrugated tube.

14. A method of feeding animals, said method comprising the steps of:
obtaining components of an animal feeder, said components comprising a corrugated tube having an outlet orifice disposed below at least one corrugation of said corrugated tube, a cap and a base, wherein said base comprises a plurality of flexible extensions each having an outwardly-disposed protuberance thereon;
assembling said corrugated tube to said base, wherein said protuberances engage the inside of a ridge portion of said at least one of said corrugations;
filling said animal feeder with feed;
installing said cap on said animal feeder; and
placing said animal feeder at a selected location.

15. The method of claim 14, further comprising the step of:
urging said protuberances into said inside of said ridge by installation of a securing ring, wherein said securing ring cooperatively engages a relieved area on an inside portion of said flexible extensions.

16. The method of claim 14, further comprising the step of:
urging said protuberances into said inside of said ridge by installation of a threaded securing ring, wherein external threads on said threaded securing ring engage internal threads on said flexible extensions.

17. An animal feeder comprising:
a corrugated tube having a top end and a bottom end;
a base, wherein said bottom end is in communication with said base, and wherein said base comprises a fastener for securing said corrugated tube to said base;
an outlet orifice disposed on said base, wherein said outlet orifice is underneath a portion of a corrugation of said corrugated tube.

18. The animal feeder of claim 17, wherein said fastener comprises flexible extensions and a ring having external threads that cooperatively engage internal threads on said flexible extensions, and wherein said flexible extensions comprise protuberances thereon, and wherein said corrugated tube comprises corrugations each having an inner valley and an outer ridge, and wherein said outer ridge comprises an inside portion, and wherein installation of said fastener urges said protuberances into said inside portion.

19. The animal feeder of claim 17, wherein said fastener comprises flexible extensions having a groove on the inside thereof and each flexible extension having a protuberance thereon, a ring edge that cooperatively engages said groove, and wherein said corrugated tube comprises corrugations each having an inner valley and an outer ridge, and wherein said outer ridge comprises an inside portion, and wherein installation of said fastener urges said protuberances into said inside portion, and wherein said ring edge is retained in said groove, thereby locking said corrugated tube to said base.

20. The animal feeder of claim 17, further comprising a horizontally-disposed baffle plate within said animal feeder, wherein said horizontally-disposed baffle plate causes feed to first flow directionally away from said outlet orifice prior to flowing toward said outlet orifice prior to exiting said outlet orifice, and wherein said corrugated tube comprises corrugations each having an inner valley and an outer ridge, and wherein said animal feeder further comprises a cover having a perimeter, wherein said cover comprises a cap and an elastic retainer, and wherein said cap comprises a plurality of slots disposed circumferentially in said perimeter, and wherein engagement of said elastic retainer with said slots permits engagement of said elastic retainer with at least one of said valleys, and wherein said engagement of said elastic retainer with said at least one valley secures said cover to said top.
